(19) United States
(12) Patent Application Publication
(10) Pub. No.: US 2018/0144865 A1
(43) Pub. Date: May 24, 2018

(54) CAPACITOR MODULE

(71) Applicant: CALSONIC KANSEI CORPORATION, Saitama-shi, Saitama (JP)

(72) Inventors: Fumihiro OKAZAKI, Saitama-shi, Saitama (JP); Gen OKUZUKA, Saitama-shi, Saitama (JP); Yuuichirou NOMURA, Saitama-shi, Saitama (JP); Masaharu NAGANO, Saitama-shi, Saitama (JP)

(73) Assignee: CALSONIC KANSEI CORPORATION, Saitama-shi, Saitama (JP)

(21) Appl. No.: 15/575,230

(22) PCT Filed: May 17, 2016
(86) PCT No.: PCT/JP2016/064536

§ 371 Date: Nov. 17, 2017

(30) Foreign Application Priority Data
May 18, 2015 (JP) 2015-101167

(51) Int. Cl. H01G 4/228; H01G 4/40; H02M 7/48; H02M 1/14; B60L 11/12; B60L 3/00; H01G 4/005

(52) U.S. Cl. CPC H01G 4/228; H01G 4/40; H02M 7/48; B60L 2210/10; B60L 11/123; B60L 3/003; H01G 4/005; H02M 1/14

(57) ABSTRACT

Provided is a capacitor module for smoothing voltage including: a substantially rectangular capacitor case; a pair of bus bars forming a plurality of positive electrodes and negative electrodes provided so as to project out towards surrounding of the capacitor case; and a pair of high-voltage wires forming a positive electrode and a negative electrode having flexibility, the pair of high-voltage wires being configured to be drawn from the capacitor case, wherein the bus bars are connected to a power module and a DC/DC converter, the power module being configured to convert direct-current electric power from a driving power supply and alternating-current electric power to be supplied to a load, and the DC/DC converter being configured to convert voltage of the direct-current electric power, and the high-voltage wires are connected to a charger configured to convert external electrical power to direct-current electric power and charge the driving power supply therewith, the external electrical power being supplied via an external connector, and the external electrical power being of lower voltage relative to the driving power supply.

### TECHNICAL FIELD

The present invention relates to a capacitor module for smoothing electrical power.

### BACKGROUND ART

In a power converter mounted on electric automobiles, hybrid automobiles, and so forth, electronic devices such as a capacitor module, power module, and so forth are provided, and there has been a problem in that the size of a housing is increased due to arrangement of respective components.

In order to solve such a problem, JP2008-099397A discloses a power converter that uses a smoothing capacitor module in which capacitor devices are connected to bus bars composed of a positive electrode and a negative electrode, which are then connected to switching power devices.

### SUMMARY OF INVENTION

The conventional technique described in JP2008-099397A has a configuration in which the capacitor module has the bus bars, and other electronic components are connected to the bus bars. With such a configuration, because positions of the other electronic components are determined by the shapes of the bus bars, the degree of freedom is decreased for arrangements of the components and modifications of the specifications. Therefore, there has been a restriction for size reduction of the power converter.

The present invention has been designed in consideration of the problem, and an object thereof is to provide a capacitor module that is capable of increasing the degree of freedom for arranging other electrical components to be connected.

According to one aspect of the present invention, a capacitor module for smoothing voltage includes: a substantially rectangular capacitor case; a pair of bus bars forming a plurality of positive electrodes and negative electrodes provided so as to project out towards surrounding of the capacitor case; and a pair of high-voltage wires forming a positive electrode and a negative electrode having flexibility, the pair of high-voltage wires being configured to be drawn from the capacitor case. The bus bars are connected to a power module and a DC/DC converter, the power module being configured to convert direct-current electric power from a driving power supply and alternating-current electric power to be supplied to a load, and the DC/DC converter being configured to convert voltage of the direct-current electric power, and the high-voltage wires are connected to a charger configured to convert external electrical power to direct-current electric power and charge the driving power supply therewith, the external electrical power being supplied via an external connector, and the external electrical power being of lower voltage relative to the driving power supply.

According to the present invention, because the capacitor module is provided with the bus bars and the flexible high-voltage wires, it is possible to increase the degree of freedom of arrangement by connecting the power module and the DC/DC converter requiring large electric current with the bus bars and by connecting the charger with the flexible high-voltage wires. With such a configuration, the size of the device (for example the power converter) in which the capacitor module is arranged can be reduced.

### BRIEF DESCRIPTION OF DRAWINGS

FIG. 1 is a functional block diagram of a power converter to which a capacitor module of an embodiment of the present invention is applied.

FIG. 2 is a structural block diagram of the power converter to which the capacitor module of the embodiment of the present invention is applied.

FIG. 3 is a structural block diagram of the power converter to which the capacitor module of the embodiment of the present invention is applied.

FIG. 4A is an upper perspective view of the capacitor module of the embodiment of the present invention.

FIG. 4B is a bottom perspective view of the capacitor module of the embodiment of the present invention.

FIG. 5 is an explanatory diagram of internal bus bars in the capacitor module of the embodiment of the present invention.

### DESCRIPTION OF EMBODIMENTS

An embodiment of the present invention will be described below with reference to the drawings.

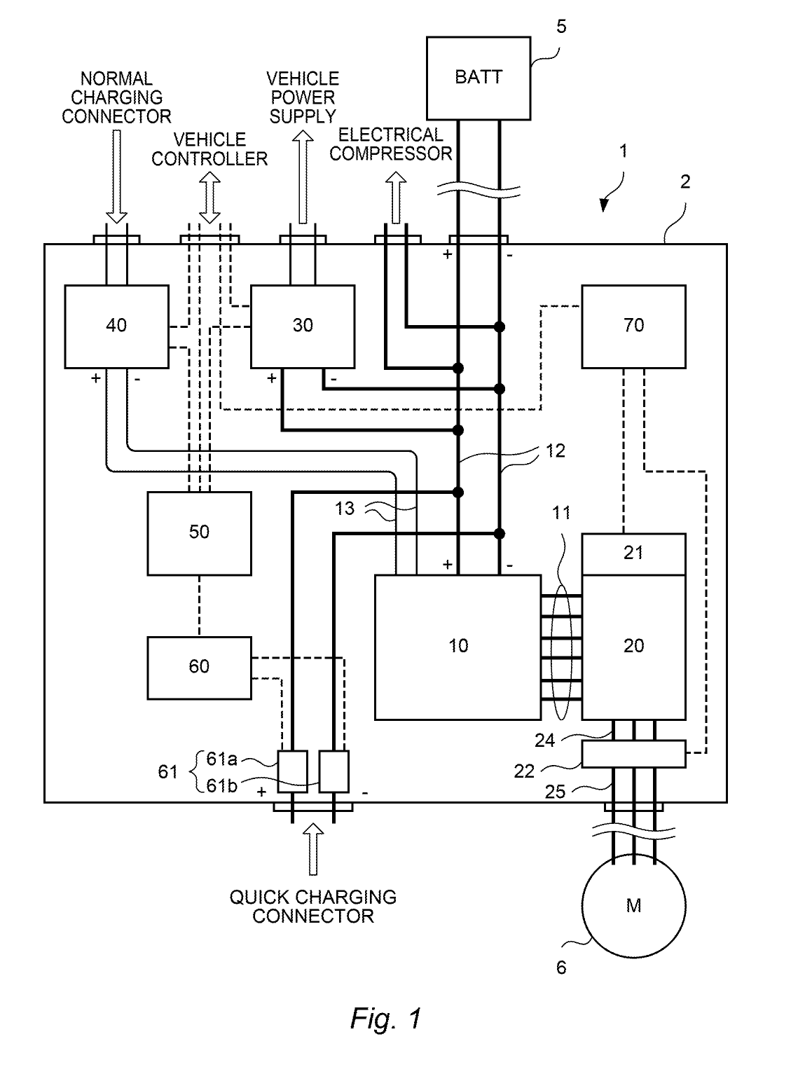

FIG. 1 is a functional block diagram of a power converter 1 to which a capacitor module of the embodiment of the present invention is applied.

The power converter 1 is provided in an electric vehicle or a plug-in hybrid vehicle, and converts electrical power from a power storage apparatus (battery) 5 to electrical power suitable for driving a dynamo-electric machine (motor generator) 6. The motor generator 6 is driven by the electrical power supplied from the power converter 1, and thereby, the vehicle is driven.

The power converter 1 converts regenerative electrical power from the motor generator 6 to direct-current electric power and charges the battery 5 therewith. In addition, the battery 5 is charged by the power converter 1 by supplying electrical power through a quick charging connector or a normal charging connector provided on the vehicle.

The battery 5 is formed of, for example, a lithium ion secondary battery. The battery 5 supplies direct-current electric power to the power converter 1, and battery 5 is charged by direct-current electric power supplied by the power converter 1. The voltage of the battery 5 varies over a range of, for example, from 240 to 400 V, and the battery 5 is charged by inputting higher voltage than this voltage.

The motor generator 6 is configured as, for example, a permanent magnet synchronous motor. The motor generator 6 is driven by alternating-current electric power supplied by the power converter 1, and thereby, the vehicle is driven. When the vehicle slows down, the motor generator 6 generates regenerative electrical power.

The power converter 1 includes, in a case 2, a capacitor module 10, a power module 20, a DC/DC converter 30, a charger 40, a DC/DC charge controller 50, and an inverter controller 70. Each of these components are connected electrically by bus bars or wires.

The capacitor module 10 is formed of a plurality of capacitor elements. The capacitor module 10 performs removal of noise and suppression of voltage fluctuation by smoothing the voltage. The capacitor module 10 includes first bus bars 11, second bus bars 12, and electrical power wires 13.

The first bus bars 11 are connected to the power module 20. The second bus bars 12 are connected to the DC/DC converter 30, relays 61, the battery 5, and an electric compressor (not shown). The electrical power wires 13 are formed of flexible cables (for example, litz wires) and are connected to the charger 40. The first bus bars 11, the second bus bars 12, and the electrical power wires 13 share the positive electrode and the negative electrode in the capacitor module 10.

The power module 20 mutually converts direct-current electric power and alternating-current electric power by turning ON/OFF a plurality of power elements (not shown). ON/OFF control of the plurality of power devices is performed by a drive substrate 21 provided in the power module 20.

The power module 20 is connected to the first bus bars 11 of the capacitor module 10. The first bus bars 11 are formed of three pairs of bus bars composed of the positive electrodes and the negative electrodes. The power module 20 is provided with three-phase output bus bars 24 formed of U-phase, V-phase, and W-phase. The output bus bars 24 are connected to a current sensor 22. The current sensor 22 includes motor-side bus bars 25 that output three-phase alternating-current electric power to the motor generator 6 side.

The inverter controller 70 outputs to the drive substrate 21 a signal for operating the power module 20 on the basis of an instruction from a controller (not shown) of the vehicle and detection result of the electric current of the U-phase, the V-phase, and the W-phase from the current sensor 22. The drive substrate 21 controls the power module 20 on the basis of the signal from the inverter controller 70. An inverter module that mutually converts direct-current electric power and alternating-current electric power is formed of the inverter controller 70, the drive substrate 21, the power module 20, and the capacitor module 10.

The DC/DC converter 30 converts voltage of direct-current electric power supplied from the battery 5 and supplies it to other devices. The DC/DC converter 30 steps down voltage of direct-current electric power from the battery 5 (for example, 400 V) to 12 V direct-current electric power. Direct-current electric power voltage of which has been stepped down is supplied as a power supply to a controller, lighting, fan, and so forth mounted on the vehicle. The DC/DC converter 30 is connected to the capacitor module 10 and the battery 5 via the second bus bars 12.

The charger 40 converts commercial power supply (for example, AC 200 V) that is supplied from an external charging connector provided in the vehicle via a normal charging connector 81 to direct-current electric power (for example, 500 V). Direct-current electric power converted by the charger 40 is supplied from the electrical power wires 13 to the battery 5 via the capacitor module 10. With such a configuration, the battery 5 is charged.

The DC/DC charge controller 50 controls driving of the motor generator 6 and charging of the battery 5 by the power converter 1. Specifically, on the basis of the instruction from the controller of the vehicle, the DC/DC charge controller 50 controls the charging of the battery 5 by the charger 40 via the normal charging connector 81, charging of the battery 5 via a quick charging connector 63, the driving of the motor generator 6, and the stepping down of voltage by the DC/DC converter 30.

A relay controller 60 controls on/off of the relays 61 by the control performed by the DC/DC charge controller 50. The relays 61 are formed of a positive-side relay 61a and a negative-side relay 61b. The relays 61 allows conduction of electricity when connection at the external charging connector is established via the quick charging connector 63 and supplies direct-current electric power (for example 500 V) supplied from the quick charging connector to the second bus bars 12. The battery 5 is charged by direct-current electric power thus supplied.

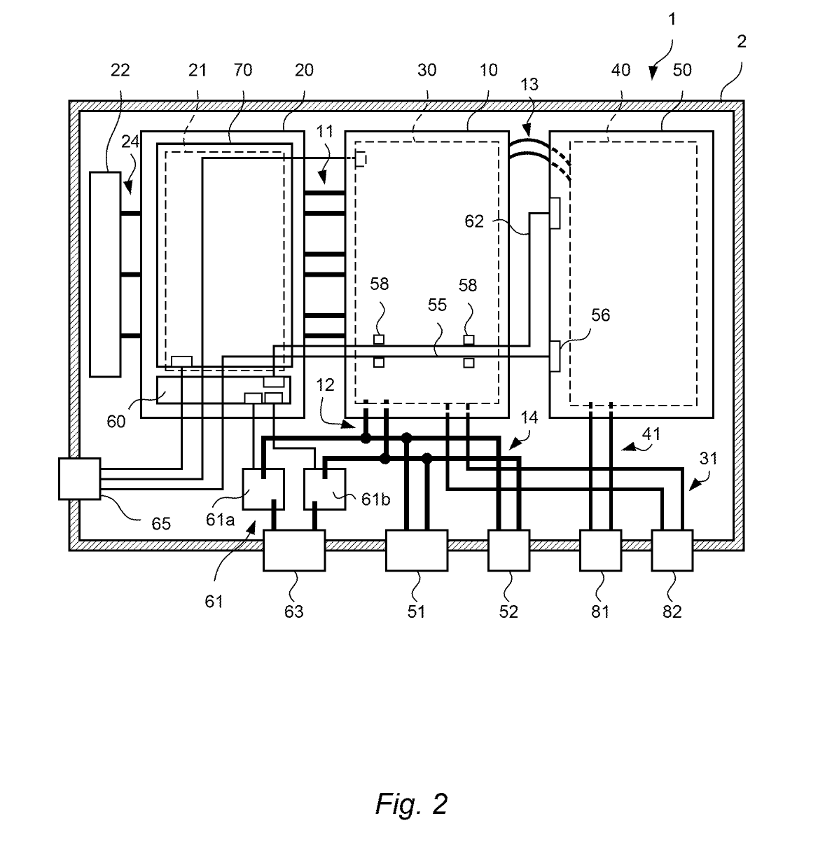

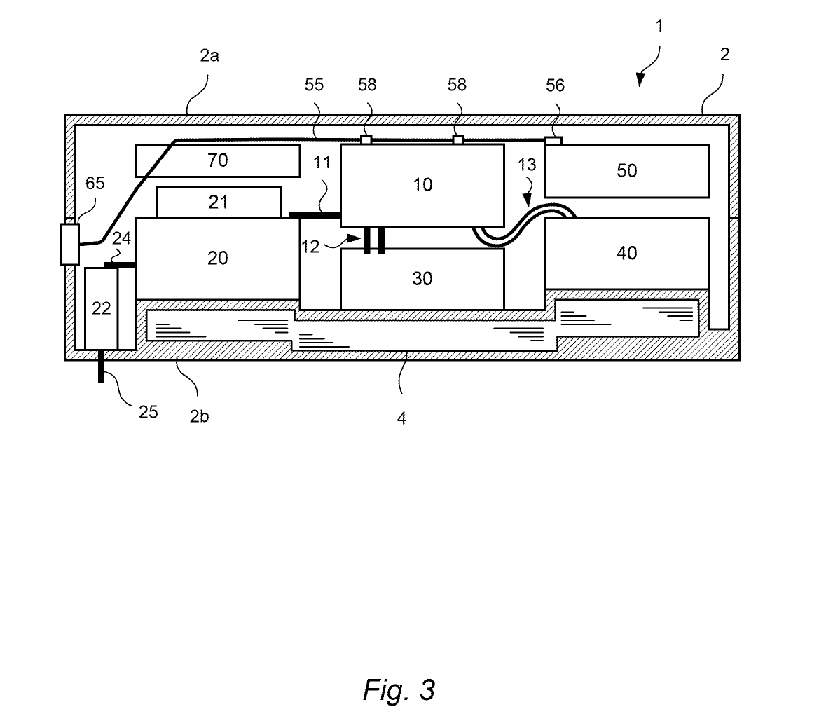

FIGS. 2 and 3 are structural block diagrams of the power converter 1 of this embodiment. FIG. 2 is a top view of the power converter 1, and FIG. 3 is a side view of the power converter 1.

In the case 2, the power module 20, the DC/DC converter 30, and the charger 40 are arranged around the capacitor module 10.

More specifically, in the case 2, the capacitor module 10 is arranged between the power module 20 and the charger 40. The capacitor module 10 is layered over the DC/DC converter 30, and the DC/DC converter 30 is arranged below the capacitor module 10. The charger 40 is layered over the DC/DC charge controller 50, and the charger 40 is arranged below the DC/DC charge controller 50.

The first bus bars 11 project out from one side surface of the capacitor module 10. The first bus bars 11 are directly connected to the power module 20 by using screws, etc. From the power module 20, three-phase output bus bars 24 composed of the U-phase, the V-phase, and the W-phase project out at the opposite side from the first bus bars 11.

The output bus bars 24 are directly connected to the current sensor 22 by using screws, etc. The motor-side bus bars 25 project out from the bottom side of the current sensor 22 (see FIG. 3). The motor-side bus bars 25 are respectively connected to the U-phase, the V-phase, and the W-phase of the output bus bars 24 of the power module 20 directly, and output three-phase alternating-current electric power. The motor-side bus bars 25 are formed so as to be exposed from the case 2 and are connected to the motor generator 6 by a harness, etc.

The drive substrate 21 is layered on a top surface of the power module 20. The inverter controller 70 and the relay controller 60 are arranged so as to be layered above the drive substrate 21.

The second bus bars 12 project out from the bottom surface side of the capacitor module 10. The second bus bars 12 are connected, by using screws, directly to the DC/DC converter 30 that is arranged so as to be layered below the capacitor module 10. The second bus bars 12 are also connected to the positive-side relay 61a and the negative-side relay 61b (see FIG. 1).

The second bus bars 12 are respectively connected via bus bars 14 to a battery-side connector 51 to which the battery 5 is connected and a compressor-side connector 52 to which an electric compressor is connected.

The DC/DC converter 30 is connected to a vehicle-side connector 82 via bus bars 31. The vehicle-side connector 82 is connected to harnesses, etc. for supplying direct-current power supply output from the DC/DC converter 30 to respective parts of the vehicle.

The electrical power wires 13 project out from the side of the capacitor module 10 opposite from the first bus bars 11. The electrical power wires 13 are flexible cables having bendability and are connected to the charger 40. The charger 40 is connected to the normal charging connector 81 via bus bars 41.

A signal line connector 65 allows connection between the outside of the case 2 and signal lines connected to the DC/DC converter 30, the charger 40, the DC/DC charge controller 50, and the inverter controller 70 of the power converter 1.

A signal line 55 is connected between the signal line connector 65 and the DC/DC charge controller 50. The signal line 55 is connected to a connector 56 of the DC/DC charge controller 50 by extending through a top surface of the capacitor module 10 together with a signal line 62 provided from the DC/DC charge controller 50 to the relay controller 60. Guide parts 58 for supporting the signal line 55 and the signal line 62 are formed on the top surface of the capacitor module 10.

The case 2 is formed of an upper case 2a and a bottom case 2b. A coolant-water channel 4 is formed in the bottom case 2b. The coolant-water channel 4 is formed such that coolant water flows therethrough and cools the power module 20, the DC/DC converter 30, and the charger 40 mounted directly above the coolant-water channel 4.

With the power converter 1 configured as described above, the capacitor module 10 is arranged so as be adjacent to each of the power module 20, the DC/DC converter 30, and the charger 40, and respective components are connected to the capacitor module 10 by the first bus bars 11, the second bus bars 12, and the electrical power wires 13. With such a configuration, because distances between the capacitor module 10 and each of the power module 20, the DC/DC converter 30, and the charger 40 can be made shorter, it is possible to reduce resistance (R) and inductance (L) on paths of direct-current electric power and to reduce electrical power loss.

Furthermore, because the capacitor module 10 is arranged between the power module 20 and the charger 40 that generate large amount of heat, it is possible to suppress mutual influence by the heat between the power module 20 and the charger 40. Especially, because operation of the power module 20 (power running and regeneration of the motor generator 6) and operation of the charger 40 (charging of the battery 5 by the normal charging connector 81) are not performed at the same time, it is possible to eliminate influence by the heat between the operations.

Next, the configuration of the capacitor module 10 will be described.

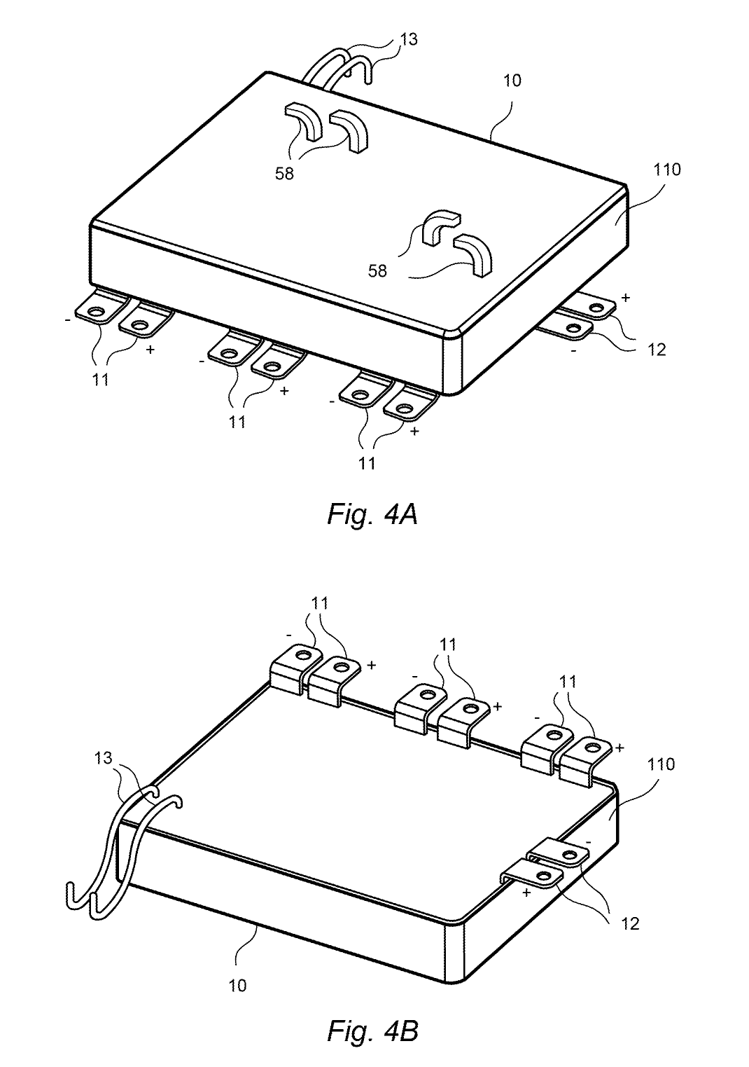

FIG. 4A is an upper perspective view of the capacitor module 10 of this embodiment, and FIG. 4B is a bottom perspective view of the capacitor module 10 of this embodiment.

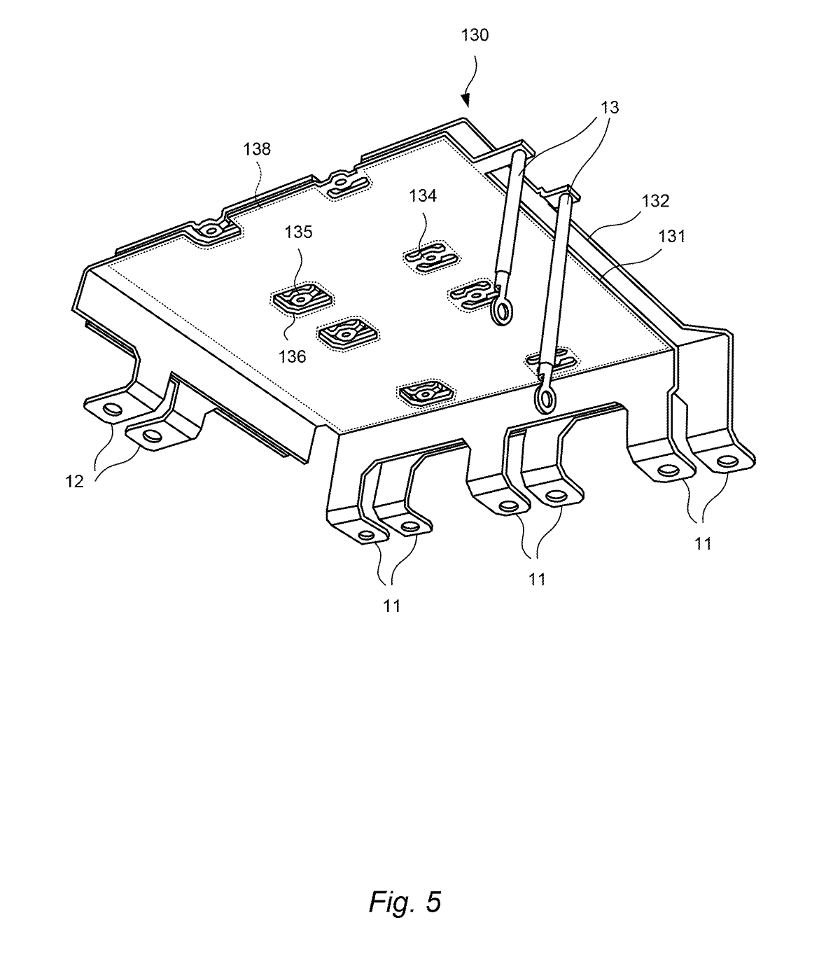

In the capacitor module 10, a plurality of capacitors are accommodated in a capacitor case 110, and the plurality of capacitor elements are electrically connected (not shown) by an internal bus bar 130 forming the positive electrodes and the negative electrodes (see FIG. 5). The capacitor elements and the internal bus bar 130 are molded into resin material.

On the top surface of the capacitor module 10, the guide parts 58 are formed. The guide parts 58 have a claw-like shape, and a plurality of guide parts 58 are formed so as to correspond to each other. The signal line 55 and the signal line 62 are fixed between the opposing guide parts 58. With such a configuration, alignment of the signal line 55 and the signal line 62 is achieved, and movement of the signal line 55 and the signal line 62 by vibrations, impacts, and so forth is prevented.

The internal bus bar is branched to each of the first bus bars 11, the second bus bars 12, and the electrical power wires 13.

The first bus bars 11 are formed of the bus bars composed of three pairs of positive electrodes and negative electrodes corresponding to three phases of the power module 20, including the U-phase, the V-phase, and the W-phase, and the first bus bars 11 are provided so as to project out from a bottom surface of the capacitor case 110 towards the one side surface.

The second bus bars 12 are formed of the bus bars composed of a pair of positive electrodes and negative electrodes and are provided so as to project out from the bottom surface of the capacitor case 110 towards a second side surface adjacent to the above-mentioned one side surface. The electrical power wires 13 consist of flexible cables with a positive electrode and a negative electrode and are provided so as to be drawn towards the bottom surface side of the capacitor case 110.

In a state in which the first bus bars 11 are installed in the case 2, the first bus bars 11 have shapes so as to be in contact with terminals corresponding to three phases, including the U-phase, the V-phase, and the W-phase, provided in the power module 20 positioned at the one side surface side of the capacitor module 10. The first bus bars 11 are connected by using screws, etc. so as to be in contact with the terminals of the power module 20.

In a state in which the second bus bars 12 are installed in the case 2, the second bus bars 12 have shapes so as to be in contact with terminals provided in the DC/DC converter 30 positioned at the bottom surface side of the capacitor module 10. The second bus bars 12 are connected by using screws, etc. so as to be in contact with the terminals of the DC/DC converter 30. The bus bars 14 are connected to the terminals of the DC/DC converter 30. The bus bars 14 are respectively connected to the relays 61, the battery-side connector 51, and the compressor-side connector 52.

In a state in which the electrical power wires 13 are installed in the case 2, the electrical power wires 13 are connected to terminals provided in the charger 40 positioned on the other side surface side of the capacitor module 10 that is opposite from the one side surface thereof. Because the electrical power wires 13 have flexibility, the electrical power wires 13 are connected to the terminals of the charger 40 such that there is no interference with the DC/DC charge controller 50 arranged above the charger 40, and with other components and structures provided in the case 2.

FIG. 5 is an explanatory diagram of the internal bus bar 130 of the capacitor module 10 of the embodiment of the present invention.

The internal bus bar 130 is composed of a positive-electrode-side internal bus bar 131 and a negative-electrode-side internal bus bar 132 that are formed in a substantially flat plate shape. The first bus bars 11 and the second bus bars 12 are formed at end portions of the positive-electrode-side internal bus bar 131 and the negative-electrode-side internal bus bar 132, and the electrical power wires 13 are connected thereto.

The positive-electrode-side internal bus bar 131 and the negative-electrode-side internal bus bar 132 are arranged by being layered so as to oppose each other in the capacitor case 110. An insulating sheet 138 is interposed between the positive-electrode-side internal bus bar 131 and the negative-electrode-side internal bus bar 132, and thereby, the positive-electrode-side internal bus bar 131 and the negative-electrode-side internal bus bar 132 are insulated.

In the positive-electrode-side internal bus bar 131, terminal parts 134 for connecting the capacitor elements are perforated, and penetrating portions 136 are formed. Terminal parts 135 formed on the negative-electrode-side internal bus bar 132 are respectively arranged in the penetrating portions 136. The positive electrodes and the negative electrodes of the capacitor elements are respectively connected to the terminal parts 134 and the terminal parts 135.

As described above, the capacitor module 10 is configured such that, in the capacitor module 10, the positive-electrode-side internal bus bar 131 and the negative-electrode-side internal bus bar 132 are arranged so as to oppose each other, and the insulating sheet 138 is interposed between the positive-electrode-side internal bus bar 131 and the negative-electrode-side internal bus bar 132. With such a configuration, it is possible to reduce the inductance (L) in the capacitor module 10.

As described above, the capacitor module 10 of the embodiment of the present invention is the capacitor module 10 for smoothing voltage and includes: the substantially rectangular capacitor case 110; a plurality of bus bars (the first bus bars 11 and the second bus bars 12) provided so as to project out towards surrounding of the capacitor case 110; and flexible high-voltage wires (the electrical power wires 13) drawn from the capacitor case 110, and the capacitor module 10 is configured such that the first bus bars 11, the second bus bars 12, and the electrical power wires 13 are respectively connected to a plurality of electronic devices (the power module 20, the DC/DC converter 30, and the charger 40).

As described above, because the first bus bars 11, the second bus bars 12, and the electrical power wires 13 are provided, electronic devices requiring large electric current are connected by the first bus bars 11 and the second bus bars 12, and other electronic devices are connected by the electrical power wires 13 having flexibility, and thereby, it is possible to increase the degree of freedom of layout about the capacitor module 10. With such a configuration, it is possible to reduce the size of a device (for example, the power converter 1) to which the capacitor module is applied.

In consideration of the electrical power loss, such as impedance, inductance, and so forth, all of the connections between the capacitor module 10 and each of the power module 20, the DC/DC converter 30, and the charger 40 should preferably be achieved by using bus bars. However, if the bus bars are to be used to achieve all connections between the capacitor module 10 and each of the power module 20, the DC/DC converter 30, and the charger 40, there may be a problem in that the ease of assembly is deteriorated, and the ease of the layout is also limited. On the other hand, although the connections may be achieved by using relatively thin flexible electrical power wires to increase the degree of freedom of the layout in the case 2 of the power converter 1, there will be a problem related to the electrical power loss. Thus, in this embodiment, the electrical power wires 13 having flexibility is used to connect the capacitor module 10 to the charger 40 that is a device in which electrical power passing therethrough is smaller relative to that of the power module 20 and the DC/DC converter 30. With such a configuration, it is possible to increase the degree of freedom of the layout while reducing influences related to the electrical power loss, and as a result, it is possible to reduce the size of the power converter 1.

In addition, the capacitor module 10 of the embodiment of the present invention includes: the first bus bars 11 that are connected to the power module 20 that converts direct-current electric power from the battery 5 and alternating-current electric power to be supplied to a load (the motor generator 6); and the second bus bars 12 that are connected to the DC/DC converter 30 that converts direct current voltage supplied from the battery 5, and the capacitor module 10 is configured such that the electrical power wires 13 are connected to the charger 40 that converts alternating-current electric power, which is supplied via an external connector (the normal charging connector 81), to direct-current electric power and that charges the battery 5 therewith.

With such a configuration, because the electrical power paths between the capacitor module 10 is the power module 20, the DC/DC converter 30, and the charger 40 can be made shorter, it is possible to reduce resistance (R) and inductance (L) on the paths of direct-current electric power in the capacitor module 10 and to reduce electrical power loss.

In addition, the capacitor module 10 of the embodiment of the present invention is configured such that the first bus bars 11 and the second bus bars 12 are provided so as to project out towards the one side of the capacitor case 110, and the electrical power wires 13 are provided so as to be drawn from the other side of the capacitor case 110. With such a configuration, because the capacitor module 10 is arranged between the power module 20 and the charger 40 that generate large amount of heat, it is possible to suppress mutual influence by the heat between the power module 20 and the charger 40. In addition, because a path for connecting a third terminal can be arranged freely, the degree of freedom of arrangement of the respective components in the case 2 is increased, and it is possible to reduce the size of the power converter 1.

Although the embodiment of the present invention has been described above, the above-mentioned embodiment is only an illustration of one of application examples of the present invention, and there is no intention to limit the technical scope of the present invention to the specific configuration of the above-mentioned embodiment.

In the above-mentioned embodiment, although the capacitor module 10 is connected to the charger 40 by using flexible cables (the electrical power wires 13), the configuration is not limited thereto. The capacitor module 10 may be connected to the charger 40 by bus bars, or the capacitor module 10 may be connected to the power module 20 or the DC/DC converter 30 by flexible cables.

Representative features of this embodiment other than those described above include followings.

(1) The capacitor module for smoothing voltage including: the substantially rectangular capacitor case; the plurality of bus bars provided so as to project out towards surrounding of the capacitor case; and the flexible high-voltage wires drawn from the capacitor case, and characterized in that the bus bars and the high-voltage wires are respectively connected to a plurality of electronic devices.

(2) The capacitor module according to (1) including: the first bus bars connected to the power module that converts direct-current electric power from the power storage apparatus and alternating-current electric power to be supplied to the load; and the second bus bars connected to the DC/DC converter that converts direct-current voltage supplied from the power storage apparatus, and characterized in that the high-voltage wires are connected to the charger that converts alternating-current electric power, which is supplied via the external connector, to direct-current electric power and that charges the power storage apparatus therewith.

(3) The capacitor module according to (2), characterized in that the bus bars are provided so as to project out towards the one side of the capacitor case, and the high-voltage wires are provided so as to be drawn from the other side of the capacitor case.

Embodiments of the present invention were described above, but the above embodiments are merely examples of applications of this invention, and the technical scope of this invention is not limited to the specific constitutions of the above embodiments.

This application claims priority based on Japanese Patent Application No. 2015-101167 filed with the Japan Patent Office on May 18, 2015, the entire contents of which are incorporated into this specification.

1. A capacitor module for smoothing voltage comprising:
a substantially rectangular capacitor case;
a pair of bus bars composed of a plurality of positive electrodes and negative electrodes provided so as to project out towards surrounding of the capacitor case; and
a pair of high-voltage wires forming a positive electrode and a negative electrode having flexibility, the pair of high-voltage wires being configured to be drawn from the capacitor case, wherein
the bus bars are connected to a power module and a DC/DC converter, the power module being configured to convert direct-current electric power from a driving power supply and alternating-current electric power to be supplied to a load, and the DC/DC converter being configured to convert voltage of the direct-current electric power, and
the high-voltage wires are connected to a charger configured to convert external electrical power to direct-current electric power and charge the driving power supply therewith, the external electrical power being supplied via an external connector, and the external electrical power being of lower voltage relative to the driving power supply.

2. The capacitor module according to claim 1, wherein
the bus bars and the high-voltage wires are provided out from the capacitor case at different locations from each other.

3. The capacitor module according to claim 2, wherein
the bus bars are provided so as to project out towards one side of the capacitor case in a planar view, and
the high-voltage wires are provided so as to be drawn from other side of the capacitor case in a planar view.

4. The capacitor module according to claim 1, wherein
the bus bars comprise:
a pair of first bus bars composed of a positive electrode and a negative electrode connected to the power module; and
a pair of second bus bars composed of a positive electrode and a negative electrode connected to the DC/DC converter, and
the first bus bars, the second bus bars, and the high-voltage wires are branched from an internal bus bar in the capacitor module.
